(19) United States
(12) Patent Application Publication
(10) Pub. No.: US 2006/0080140 A1
(43) Pub. Date: Apr. 13, 2006

(54) System and method for providing a clinical summary of patient information in various health care settings

(75) Inventors: Mark Duane Buttner, Middleton, WI (US); William Walter Vanderson, Madison, WI (US); Samuel LeRush Butler, Madison, WI (US); Christopher John Alban, Madison, WI (US)

Correspondence Address: GODFREY & KAHN S.C., 780 NORTH WATER STREET, MILWAUKEE, WI, 53202, US

(73) Assignee: Epic Systems Corporation

(21) Appl. No.: 10/961,772

(22) Filed: Oct. 9, 2004

Related U.S. Application Data
(60) Provisional application No. 60/543,055, filed on Feb. 9, 2004.

(51) Int. Cl. G06Q 50/00

(52) U.S. Cl. 705/2; 715/781

(57) ABSTRACT

A system and method for providing a clinical summary of patient data in a health care setting. The system and method comprises a graphical user interface in communication with a health information system for accessing patient data. The graphical user interface is capable of displaying a clinical summary of patient data in a summary window in a textual format and a graphical format. The system and method further comprises a user record allowing a user to specify and configure the patient data displayed in the summary window. The user record includes configuration and security settings for selectively controlling the display of the user-specified patient data, and a user can select from the displayed patient data, access additional information about the selected patient data, generate detailed reports including the selected patient data, and generate graphical representations including the selected patient data.

### CROSS-REFERENCE TO RELATED APPLICATIONS

This application is based on and claims the benefit of U.S. Provisional Application No. 60/543,055, filed on Feb. 9, 2004, and incorporated herein by reference.

### BACKGROUND OF THE INVENTION

The present invention relates generally to health care records and patient information management, and more particularly to an integrated system and method for providing a clinical summary of patient information, condensing large volumes of data that typically exists in health care settings into a convenient electronic summary that displays important clinical information about a patient and gives health care providers easy access to a great deal of important patient clinical information.

In providing health care to patients, especially in acute care settings, it is necessary to continuously monitor and maintain clinical information on patients. This information typically includes vital signs of the patient, clinical documentation, laboratory orders and results, ventilator settings, biomedical device data, definable patient alerts, medication information, nutrition, intake and output of the patient, and other clinical information. This information has historically been manually recorded in paper records or flowsheets. For reference, an example of a prior art paper flowsheet is shown in FIG. 12.

Access to clinical information on patients is typically provided through paper records such as paper charts or flowsheets, or through a variety of electronic systems such as software applications typically related to the type of service being provided.

Clinicians using these paper and electronic recordkeeping systems must spend much of their time analyzing, validating, and summing up all of the information collected about their patients in order to properly and effectively evaluate the patient's condition. This is true of clinicians in all health care settings, but is especially true for clinicians in acute care settings such as an intensive care unit (ICU) of a hospital. The clinically ill patients in the ICU generally require more tests, monitoring, and medications than other patients, and thus generate large amounts of data in very short periods of time. To determine the best treatments, clinicians must repeatedly dedicate time to manually sorting, summarizing and interpreting all of the data generated by their patients since the clinicians' last visits.

Current paper and electronic recordkeeping systems and methods for recording and presenting this data for evaluation have many disadvantages. With paper systems, various health care professionals enter information on frequently fragmented paper records. For example, nurses record each dose of medication administered to the patient, and various other clinicians might record tests that have been performed on the patient. Some paper systems have been designed in an attempt to convey information to clinicians in the most efficient way, and some of these paper systems include data presented in a graphical format to show trends for a particular set or modality of patient data. While these improvements do help increase the efficiency with which a clinician can evaluate the data, there are still significant problems associated with the use of a paper system. For instance, the paper record may contain all information gathered about the patient, requiring clinicians to first determine which information is relevant to their current evaluation. Clinicians may only need to see data for the last 24 hours, for example, or may not need to see data related to certain medications or procedures. This determination may be further impaired by a number of factors including disparate records and illegible handwriting. Filtering data in the paper record can add unnecessary time to clinicians' patient evaluations, and may cause clinicians to inadvertently overlook important information. Further, clinicians may not have time to review or access information they need to make quick decisions when immediate clinical care is needed. In addition, a paper record can only physically be in one place at one time. Thus, when one clinician is reviewing or updating it, other clinicians cannot access it.

Many electronic recordkeeping systems also attempt to organize information in ways that facilitate efficient medical evaluation. Some electronic systems provide the option of showing data in a graphical format. As with paper systems, however, most electronic systems generally do not adequately filter information to show only relevant patient data. Current electronic systems are, moreover, generally “niche” systems specializing in providing data about a specific aspect of patient care. These niche systems are not fully integrated, and often require hand-entry of laboratory or medication orders, laboratory results, and assessment information, making a comprehensive summary difficult and causing time delays between the time data is resulted and the time it is entered into the system. Laboratory test results and data from patient monitoring equipment, for example, are typically recorded in two different electronic record keeping systems such that a clinician needing both types of information would need to access two separate electronic systems. Further, current electronic systems do not allow a user to view the data in multiple fashions or alert the user to significant details.

Graphical representations of the data in current electronic systems are likewise limited. For instance, blood gas values are typically recorded in an electronic system that stores laboratory results. Vent settings on a ventilator, however, are typically stored in a separate electronic system that records readings from patient monitoring equipment. Clinicians must know both a patient's blood gas values and corresponding vent settings in order to evaluate the proper treatment for patients with respiratory problems. Thus, the ability to see both results together on one screen would be a very beneficial review tool for clinicians, allowing them to see potential relationships at-a-glance.

Using the current paper and electronic recordkeeping systems, relevant patient information is not available in one place for easy, efficient review. As a result, information can be easily overlooked or completely unseen when a clinician must make a treatment decision.

Given the limitations and problems with the prior art systems and methods described above, there exists a need for an improved health care records system that provides an integrated, real-time clinical summary of patient information in various health care settings. The present invention provides improvements over the prior art systems and methods described above, and to solutions to the problems raised or not solved thereby.

### SUMMARY OF THE INVENTION

The present invention provides a system and method for providing a clinical summary for patients in a health care setting. The clinical summary system and method comprises a graphical user interface in communication with a health care information system for accessing patient data. The graphical user interface is capable of displaying a clinical summary of the patient data in a summary window. The clinical summary system and method further comprises a user record allowing a user to specify and customize patient data displayed in the summary window. Preferably, the present invention also includes configurable security settings for selectively controlling the display of the user-specified patient data.

The summary window preferably comprises an events pane that displays all of the events that have been recorded for a patient within a specified range of time and a measurements pane that displays a patient's flowsheet data in a series of line graphs for a user-specified time period. The events pane displays information on patient events, such as lab results and medication administrations, and the measurements pane displays user-specified sets of data graphically. The events pane displays the user-specified patient data organized as a list of patient events preferably including a plurality of event types. The events pane preferably also supports multiple views, including a list of patient events by time, a list of patient events by type, and a list of current patient status. The list of patient events by time displays the user-specified patient data organized in data depositories and listed in chronological or reverse chronological order for a user-specified time span. The list of patient events by type displays the user-specified patient data organized in data depositories and grouped by event type for a user-specified time span. The list of current patient status displays the user-specified patient data organized in data depositories and pertaining to a patient's current status. Patient events can preferably be displayed in different user-specified colors corresponding to event types, and the events pane displays event types, event times, and event values.

The measurements pane displays the user-specified patient data in a graphical format. The graphical format preferably includes visually identifiable data points corresponding to the user-specified patient data displayed in the graphical format. Users can select a data point from the measurements pane and access additional information about the data point. The measurements pane can preferably display multiple sets of patient data simultaneously, and each set of data is displayed in a different user-specified color or line type.

The patient data displayed in the summary window includes abnormal, normal, preliminary, and final patient data. The abnormal data is preferably displayed differently than the final patient data to alert users to the presence of abnormal data, and likewise, the preliminary data is preferably displayed differently than the final data to alert users to the presence of preliminary patient data. Users can also select from the patient data displayed in the summary window, access additional information about the selected patient data, generate detailed reports including the selected patient data, and generate graphical representations including the selected patient data. Preferably, the summary window displays data for a user-specified time span, and can be configured to allow a plurality of time spans to be displayed from which the user can choose a particular time span to be displayed. In addition, the user-specified patient data can include multiple types of patient data. A first type of patient data can be correlated and displayed together with a second type of patient data to show a potential relationship between the first and second types of data, or a first type of data can be associated with a second type of patient data based on a user-specified time span.

The summary window is preferably configured by the user's profile and security settings. The summary window is a graphical user interface that displays the clinical summary. The user record includes information specific to the particular user, such as the types of data, patient events, layout, and organization, the user would like to see in the summary window. Security settings may control the types of information and actions available to a user. A user's system administrator can preferably configure the user record and security settings to meet the user's needs. The clinical summary system interacts with an Enterprise Health Information System (EHIS) to access a diverse range of patient data. The information in the user record and security settings then control the patient data displayed in the summary window.

The present invention also provides a system and method for providing an overview of patient information, condensing large amounts of patent data into a single summary window, thereby giving providers easy access to a great deal of patient information. The system and method comprises a health care information system having at least one data depository for storing patient data and at least one graphical user interface for reviewing the summary. The present invention allows clinicians to view an integrated, comprehensive clinical summary of their patients in various health care settings. The clinical summary system is highly configurable, allowing clinicians and other health care professionals to customize the system to meet their needs. A renal specialist, for example, could customize her summary system to show only the data that affect or are otherwise relevant to a patient's renal health. By eliminating the need for the specialist to sort through all of the patient's medical information in search of relevant data, the specialist is able to evaluate the patient's condition much more quickly and effectively.

Although the clinical summary system of the present invention can be used in numerous health care settings and for various purposes, it is more useful in acute care settings, such as the ICU, because critical care patients generate the largest amount of data in the shortest amount of time, and need the most attention from their clinicians. ICU clinicians can use the clinical summary system to quickly review the patients' clinical information and efficiently evaluate the patients' current conditions to determine appropriate treatments.

The present invention also contemplates a method for providing a clinical summary of patient data in a health care setting. The method includes the steps of providing a graphical user interface in communication with a health information system for accessing patient data, the graphical user interface capable of displaying a clinical summary of the patient data in a summary window in a textual format and a graphical format, selecting the patient data to be displayed, and displaying the selected data in a summarized form in the summary window.

The clinical summary system of the present invention has several advantages over prior art systems. For example, the present invention allows users to quickly view the relevant information collected on their patients since the last visit or evaluation. The clinical summary system allows users or system administrators to configure the system to select the patient data to be displayed, allowing users or system administrators to exclude certain patient data that is not relevant to the clinician's treatment of the patient and thus eliminating the time-consuming process of filtering the data and significantly decreasing the risk that a clinician may inadvertently overlook important data. Further, the clinical summary system of the present invention is in communication with a health care information system, which provides for the real-time integration of a diverse range of patient data, so that multiple types of patient data typically stored in different systems can be easily correlated and displayed together to show a potential relationship.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of an enterprise health care information system in accordance with the present invention;

FIG. 2 is a sample screen shot illustrating an embodiment of a clinical summary window of patient information in accordance with the present invention;

FIG. 3 is a sample screen shot illustrating the events pane of the clinical summary window of FIG. 2;

FIG. 4 is a sample screen shot illustrating the measurements pane of the clinical summary window of FIG. 2;

FIG. 5 is a sample screen shot illustrating an embodiment of a clinical summary of patient information in accordance with the present invention;

FIG. 6 is a sample screen shot illustrating the events pane in an “Events By Time” view of data displayed in a clinical summary of the present invention;

FIG. 7 is a sample screen shot illustrating another embodiment of a clinical summary of patient information in accordance with the present invention;

FIG. 8 is a sample screen shot illustrating another embodiment of the events pane in an “Events By Type” view of data displayed in a clinical summary of the present invention;

FIG. 9 is a sample screen shot illustrating still another embodiment of a clinical summary of patient information in accordance with the present invention;

FIG. 10 is a sample screen shot illustrating the events pane in a “Current Status” view of data displayed in the clinical summary of FIG. 9;

FIG. 11 is a diagram illustrating the configuration settings for the clinical summary of the present invention; and

FIG. 12 is an example of a prior art patient flowsheet.

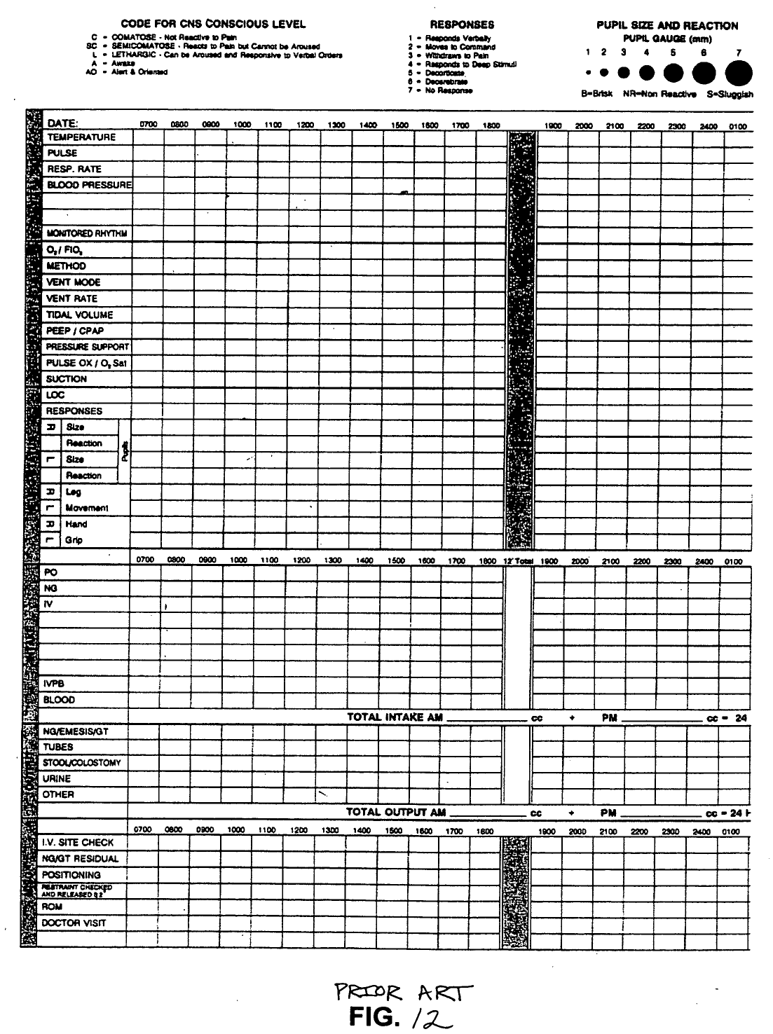

### DETAILED DESCRIPTION OF THE INVENTION

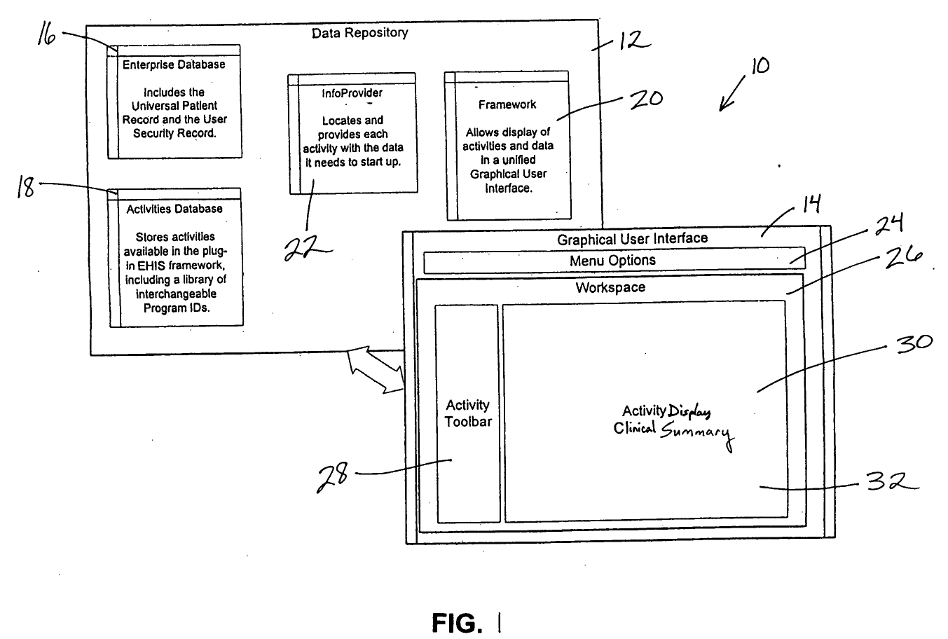

Referring now to the drawings, FIG. 1 is a block diagram of an enterprise health care information system 10 of the present invention. The enterprise health care information system 10 provides integration of health care records and health care records management, and facilitates access to health care records in a health care environment. The enterprise health care information system 10 preferably comprises a plurality of integrated software applications and allows users to move between the plurality of software applications.

The integrated enterprise health care information system 10 preferably includes at least one data repository 12 for storing data and at least one graphical user interface 14 for accessing data. The data repository 12 is in communication with the graphical user interface 14. The data repository 12 preferably stores information related to system users and patients, including an enterprise database 16 with a universal patient record having data collected for each patient and security functions defining security parameters for system users, and an activities database 18. The universal patient record preferably includes information related to health care delivery for a patient and information related to health care delivery management for the patient. System users have access to the universal patient record through one or more user interfaces in communication with the universal patient record. The security functions provide the ability to limit access to patient data displayable in the clinical summary system of the present invention. The data repository 12 further includes a modular framework 20 for supporting a plurality of patient care and health care facility resource management activities and an information provider 22 for providing each activity with its required data in communication with each other, and in communication with the enterprise database 16 and the activities database 18 which stores a plurality of activities for providing various aspects of patient care. These activities include, but are not limited to, activities used in providing health care to a patient and activities used in managing the health care provided to the patient.

In a preferred embodiment of the invention, the graphical user interface 14 comprises a menu options area 24 and a workspace area 26 with an activity toolbar area 28 and an activity display area 30 for displaying a clinical summary 30 of patient information in text and graphical format in a summary window 32. The clinical summary 30 provides an overview of patient information, condensing large amounts of data about a patient into a convenient report that displays a patient's laboratory results, medication administrations, flowsheet data, and other clinical information into a single summary window 32, thereby giving providers easy access to a great deal of patient information. The clinical summary 30 is preferably highly configurable. A user can change the reports that display throughout the activity, specify actions and events that are excluded from the display, determine the flowsheet information that appears in the measurements pane graph, and modify several other settings that determine how the summary appears.

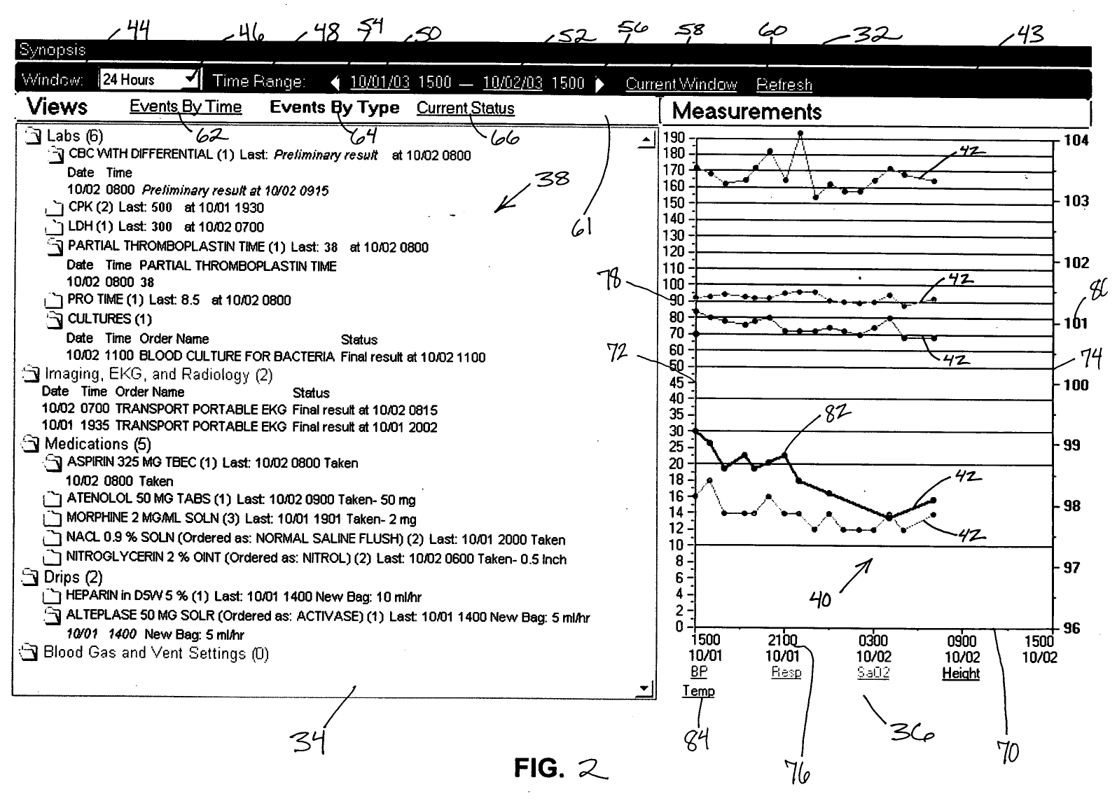

FIG. 2 illustrates a sample screen shot of an embodiment of a clinical summary window 32 of patient information in accordance with the present invention. The clinical summary window 32 preferably comprises an events pane 34 that displays all of the events 38 that have been recorded for a patient within a specified range of time and a measurements pane 36 that displays a patient's flowsheet data 40 in a series of graphs 42. The events pane 34 displays user-specified patient data as a textual list of patient events 38, and the measurements pane 36 displays user-specified sets of patient data 40 in a graphical format, such as a series of line graphs 42. Patient events 38 preferably include all actions taken, procedures performed, and measurements recorded for the patient, including but not limited to medication administrations, laboratory tests, surgical procedures, and biomedical device readings.

The clinical summary window 32 also preferably comprises various fields, views, hyperlinks and user actions available for viewing events in the events pane 34 and data in the measurements pane 36. A plurality of time window user actions 43 are available for selecting and/or changing the range of time for viewing patient events in the summary window 32, and a plurality of views user actions 61 for selecting and/or changing the views for viewing patient events in the events pane 34 of the summary window 32.

The plurality of time window user actions 43 includes a “Window” field 44 that allows a user to choose the window or range of time for which patient events 38 and measurements 40 are displayed. The time windows lengths are definable and configurable by the user to allow for any span of time to be displayed. The default time window is also defined and set by the user. The window or range of time can be changed or selected to a predefined window of time by the user clicking on or selecting the “Window” arrow button 46 to select or change the window or range of time, such as 24 hours, as shown in FIG. 2. A “Time Range” field 48 allows a user to select a starting date and time and an ending date and time for setting the time window in viewing patient events. A plurality of time window hyperlinks are included to select or change the start and end dates. A “from date” hyperlink 50 is available to select the start date and time for viewing patient events in the summary window 32. A “to date” hyperlink 52 is available to select the end date and time for viewing patient events in the summary window 32. Executing the “from date” or “to date” hyperlinks 50, 52 displays a calendar from which the user can select the start date and time and the end date and time for viewing patient events, but other methods for selecting the dates and times may also be used. A backward window hyperlink (<) 54 is used to go back one window of time. Executing the backward window hyperlink 54 takes the user back one window of time. A forward window hyperlink (>) 56 is used to advance forward one window of time. Executing the forward window hyperlink 56 takes the user forward one window of time. The “Time Range” field 48 can also be used be to review past dates and times.

The plurality of time window user actions 43 also include a “Current Window” hyperlink 58 for viewing patient data at the current date and time, and a “Refresh” hyperlink 60 for refreshing the patient data in real-time for the selected window of time. Executing the “Current Window” hyperlink 58 displays the patient data for the current date and time based on the time range or value showing in the “Window” field 44. Executing the “Refresh” hyperlink 60 updates the patient data in the summary window 32 with the most recent data about the patient, in real-time. Alternatively, the system may be configured to refresh automatically after a certain specified period of time.

The events pane 34 displays information on patient events in an “Events By Time” view, an “Events By Type” view or a “Current Status” view. These different views are initiated by executing an “Events By Time” hyperlink 62, an “Events By Type” hyperlink 64 and a “Current Status” hyperlink 66. Patient events typically included in the events pane 34 are medication administrations, drip administrations, culture results, laboratory results, blood gas and vent settings, imaging results, radiology results, EKG results, and other results information. The “Events By Time” view shows patient event information organized by date and time. Executing the “Events By Time” hyperlink 62 displays patient event information for the selected time window by date and time in the events pane 34. The “Events By Type” view shows patient event information organized by event type, i.e., laboratory results, medication administrations, blood gas and vent settings, etc. Executing the “Events By Type” hyperlink 64 displays patient event information for the selected time window by event type in the events pane 34. The “Current Status” view displays the most recently recorded information about the patient, including the patient's problem list and nutritional information. Executing the “Current Status” hyperlink 66 displays the most recently recorded patient event information for the selected time window. The “Current Status” view is not affected by the selected time window.

The measurements pane 36 preferably displays a series of line graphs 42 on a graph that graphically illustrate the patient's flowsheet information for the specified time range. The patient's flowsheet information comes from flowsheet values recorded in the documentation flowsheet activity. The measurement data 40 is viewed over time and includes individual measurement values. A dot 82, representing a measurement value, is displayed on the graph to indicate that a measurement was made at the corresponding date and time. The graph preferably includes a horizontal axis 70 and at least two vertical axes 72, 74. Dates and times 76, determined by the selected time range, are displayed along the horizontal axis 70, while measurement values 78, 80 are displayed along the vertical axes 72, 74. As shown in FIG. 2, the left side vertical axis 72 uses a graduated scale having a range from 0 to 190 and the right side vertical axis 74 uses a linear scale having a range from 96 to 104, representing temperature values in degrees Fahrenheit. A different line graph 42 is displayed for each measurement. For each measurement on the graph, a corresponding hyperlink 84 is displayed below the graph.

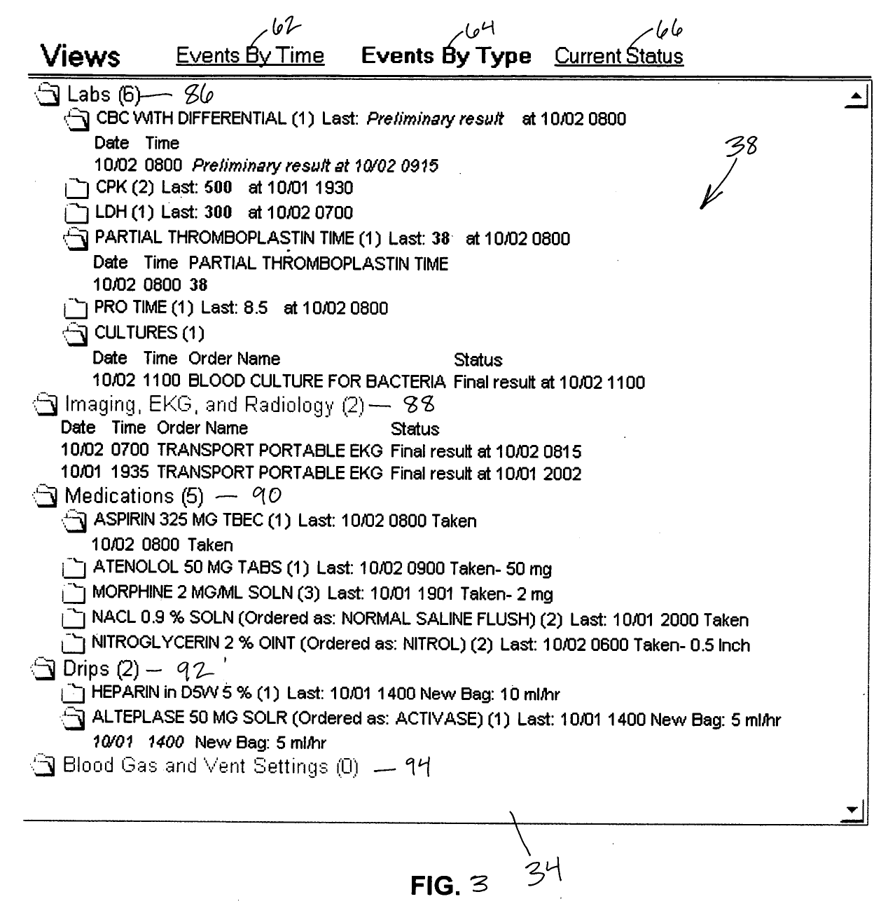

FIG. 3 illustrates a sample screen shot of the events pane 34 of the clinical summary window 32 of FIG. 2, in an “Events By Type” view. As previously described, the events pane 34 shows user-specified patient data displayed as a list of patient events 38. The events pane 34 preferably includes a plurality of different views, such as a list of patient events by time, a list of patient events by event type, and a list of patient events pertaining to the patient's current status. A user can choose which view to display by selecting one of the “Events By Time” 62, “Events By Type” 64, or “Current Status” 66 hyperlinks. In FIG. 3, the list of patient events 38 is organized by event type. The event types shown in FIG. 3 include “Labs” 86, “Imaging, EKG, and Radiology” 88, “Medications” 90, “Drips” 92, and “Blood Gas and Vent Settings” 94. Other event types may also be defined by the user and included in the events pane, and any patient data stored in the health care information system can be included in the events pane as patient events, including but not limited to vital signs of the patient, clinical documentation, laboratory orders and results, ventilator settings, biomedical device data, definable patient alerts, medication information, nutrition, intake and output of the patient, and any other available clinical data. The event types and the event data are probably organized as folders or data depositories. These data depositories display the patient's events by event type. For example, all laboratory results are displayed in the labs folder 86. To view the information under a folder, click or perform the necessary user action on the folder to open it. To hide the information under a folder, click or perform the necessary user action on the folder again to hide the data. The root-level folders or data depositories are open by default when a user access the clinical summary of a patient.

The labs folder 86 preferably displays a subfolder for each type of laboratory order that was resulted during the selected window of time. Components are displayed by procedure name. The latest results are displayed on the same line as the procedure name. Clicking or performing the necessary user action on one of the lab orders will pull up a detailed order report. Next to each subfolder, the most recent results and the date and time of those results are displayed. Preliminary patient data is displayed differently than final patient data to alert the user to the presence of the preliminary patient data. If the results are preliminary, the text “Preliminary result” appears instead of the result values. For example, FIG. 3 shows the text “Preliminary result” to indicate preliminary patient data. Similarly, abnormal patient data is preferably displayed differently than normal patient data to alert the user to the presence of abnormal patient data. In a preferred embodiment, abnormal patient data is highlighted or displayed in a distinguishable font and/or typeface, such as a bolded, red typeface, as shown in FIG. 3. If the user does not have access to sensitive information about the patient, sensitive orders are not displayed. A user can open each subfolder to view the results for each laboratory order of that type. If the current day is included in the time window, then all laboratory orders that have been resulted today are displayed, even if those orders were resulted outside of the selected time window. Laboratory orders that were resulted on the current day but were resulted outside of the selected time window are displayed in a distinguishable font and/or typeface. Note that some components may be excluded from the display for convenience. For example, a CBC consists of several components, but some of those components may not be relevant to the medical decision-making process, so they may be excluded. Components are excluded based on settings in the user profile record.

The imaging, EKG and radiology folder 88 preferably displays a list of the results of all imaging, EKG, and radiology orders that were collected during the selected window of time. Components are displayed by procedure name. The latest results are displayed on the same line as the procedure name. Clicking or performing the necessary user action on one of the imaging orders will pull up a detailed order report. Orders that were resulted on the current day but were collected outside of the selected time window are displayed in a distinguishable font and/or typeface. If the user does not have access to sensitive information about the patient, sensitive orders are not displayed.

The medications folder 90 preferably displays a subfolder for each type of medication that was administered to the patient during the selected window of time. Preferably, only the medications administered are shown. The latest administration is preferably listed on the same line as the medication name. Next to each subfolder, the date and time of the most recent administration is preferably displayed. A user can open each subfolder to view information about each administration of the medication that occurred during the selected window of time. Note that some actions may be excluded from the display for convenience. For example, a user may not need to see medications that were missed, so missed administrations may be excluded from the display. Actions are excluded based on settings in the user profile record.

The drips folder 92 preferably displays a subfolder for each type of medication that was administered to the patient via a drip bag during the selected window of time. Preferably, only the medications administered are shown. The latest administration is preferably listed on the same line as the medication name. The system preferably checks for drips that have started up to 24 hours prior to the start of the selected time window. This is done so that any currently-running drips that were started before the selected time window are included in the display, even if no actions were taken on those drips during the selected time window.

The blood gas and vent settings folder 94 preferably displays a list of blood gas components and vent settings. Blood gas result components and vent setting data from the flowsheet are preferably combined into a single row based on the time of collection or entry. The blood gas components preferably come from result components that are part of laboratory procedures, and the vent settings preferably come from values recorded in the documentation flowsheet activity. Which blood gas and vent settings are displayed is determined by settings in the user profile record. Blood gas information is preferably matched to vent settings based on the collection time of the blood gas components. The system preferably looks for a vent setting an hour prior to the collection time. This look back time can be changed. If a vent setting is not matched to a blood gas component, the vent setting preferably appears in the display as its own line of data.

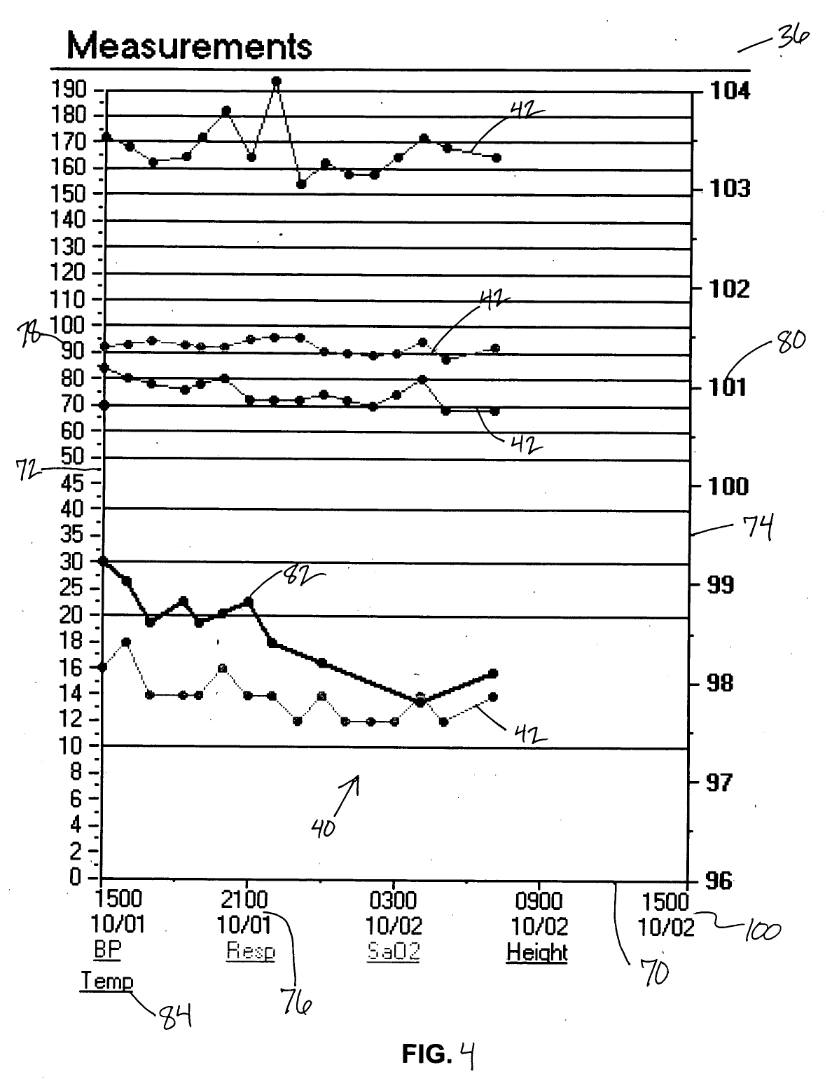

FIG. 4 illustrates a sample screen shot of the measurements pane 36 of the clinical summary window of FIG. 2. The measurements pane 36 preferably displays a series of line graphs 42 that illustrate the trends of user-specified patient data, or measurement data, for the specified window or range of time. The information on the graph preferably comes from flowsheet values recorded in the documentation flowsheet activity, and each measurement comes from a different flowsheet row. The flowsheet rows that appear in the graph are set in the user's profile record. A separate line graph 42 is preferably displayed for each type of measurement data, such as blood pressure, respiration, oxygen saturation, and temperature measurement data, etc. The line graphs 42 are preferably displayed in different colors to help differentiate between the measurements. Dates and times 76 are preferably displayed along a horizontal axis 70 of the graph. The dates and times 76 are determined by the current time ranges. The measurement values are displayed along the vertical axes 72, 74 of the graph. The vertical axis 72 on the left side of the graph uses a graduated scale and has a range from 0 to 190. For each horizontal line for values between 0 and 20, each line represents two units; for values between 20 and 50, each line represents five units; for values between 50 and 190, each line represents ten units. If the user profile is set up to include a temperature row, an additional vertical axis 74 appears on the right side of the graph. This axis 74 has a range from 96 to 104 and represents temperature values in degrees Fahrenheit. The system may also be configured to display the measurement data in any other graphical format. If a set of data includes two event values per measurement, as is the case with blood pressure measurements, both event values are plotted on the measurements pane 36 as separate data points, comprising two separate line graphs 42.

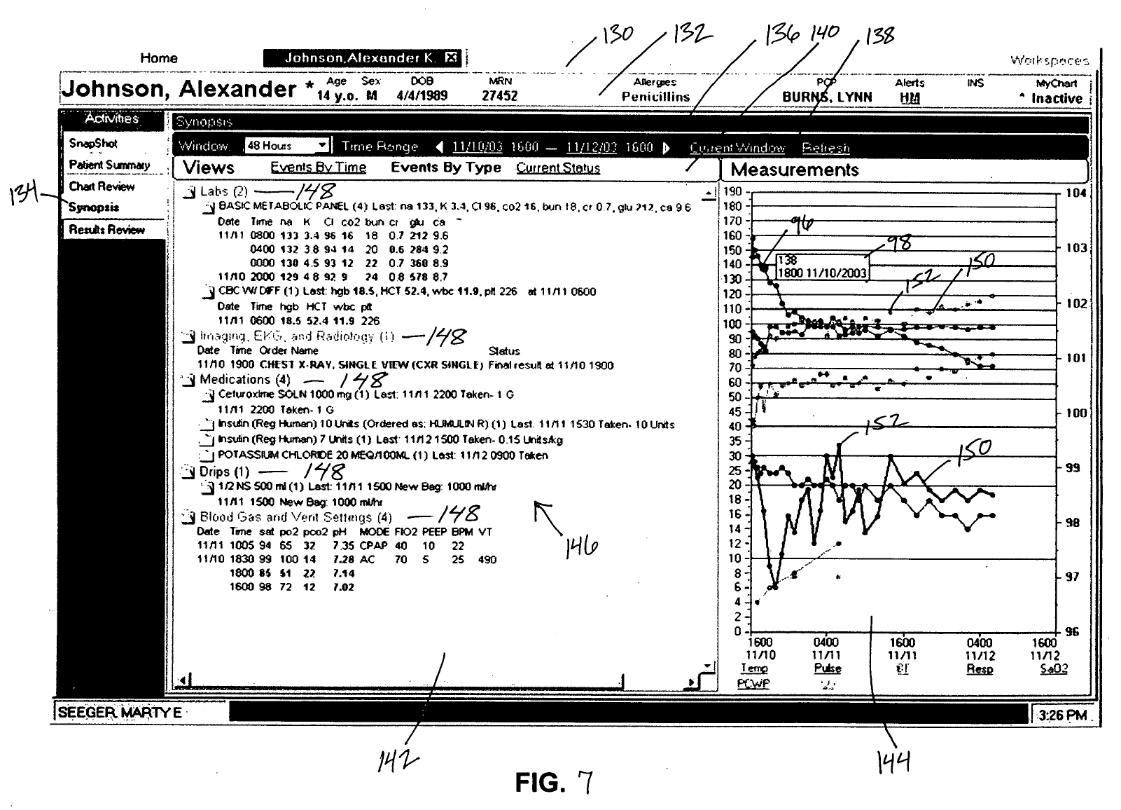

Users can also view the individual data points that comprise the graphs, and additional information pertaining to the data points. For example, as shown in FIG. 4, a dot 82 is displayed on the graph to indicate that a data point was generated at the corresponding time. When a user hovers a pointing device over a dot 96, the dot 96 enlarges and a “ToolTip” or information summary box 98 is displayed to provide information about the data point 96, as shown in FIG. 7. As with patient events 38 and event values, measurement data points 82 are executable actions. Users could, for instance, select a data point 82 and access additional information about the data point 82 from another activity or module in the health care information system, or save all the data associated with the data point 82, such as its event type and event value, for later use in documentation.

The measurements pane 40 also includes an interactive legend 100 with interactive hyperlinks 84 for each measurement. When a measurement appears on the graph, its hyperlink 84 is displayed in the same color as the line graph 42. For each graph 42 displayed in the measurements pane 36, a corresponding user action hyperlink 84 is displayed on the legend 100 below the graph. A user can execute the corresponding user action hyperlink 84 to display or hide the graph 42. Each user action hyperlink 84 on the legend 100 is preferably displayed in the same color as its corresponding graph 42. For example, temperature measurement data is displayed as a blue line graph 42, and the corresponding user action hyperlink 84 below the graph, labeled “Temp,” is also displayed in blue. When a user executes a user action, it will turn gray or another distinguishable color to indicate that the graph is now hidden but available for display by executing the user action hyperlink, such as the “Height” measurement hyperlink shown in FIG. 4.

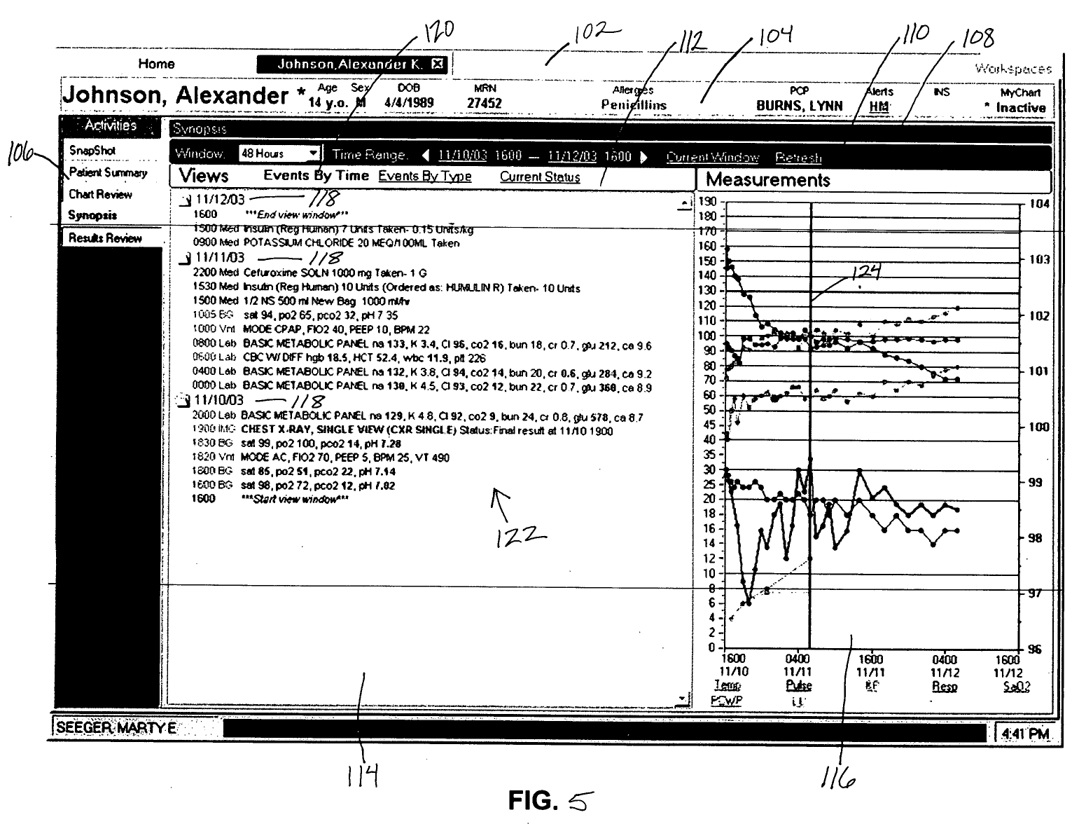

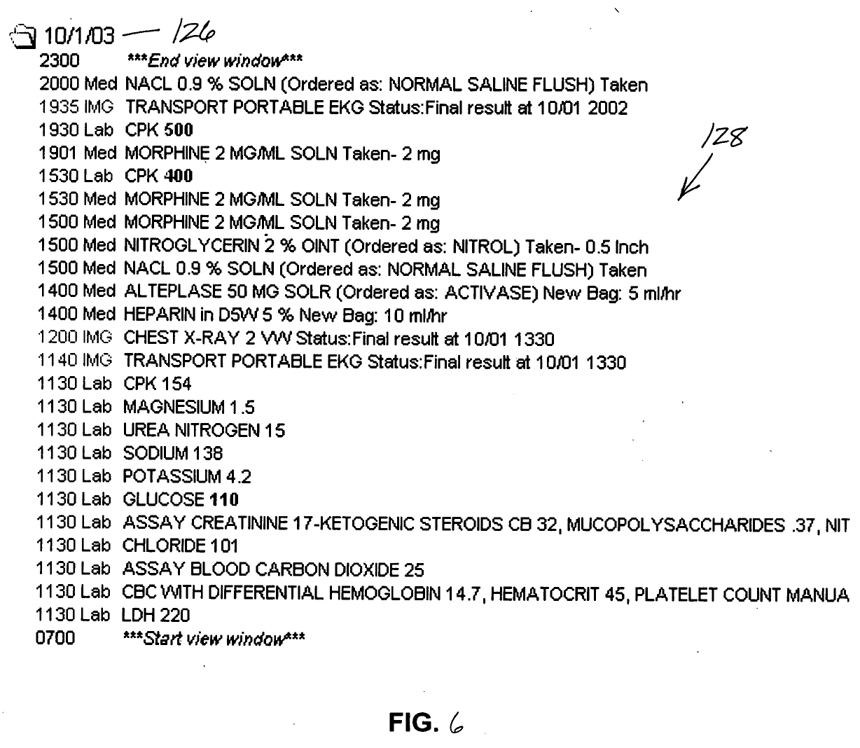

FIG. 5 is a sample screen shot illustrating an embodiment of a clinical summary 102 of patient information in accordance with the present invention. The clinical summary 102 preferably includes a patient name and information area 104 above a clinical summary window 108 and an activities area 106 next to the clinical summary window 108. The clinical summary 102 further includes a time window user action area 110 for selecting and/or changing the range of time for viewing patient events in the summary window 108, a views user action area 112 for selecting and/or changing the views for viewing patient events in the summary window 108, an events pane 114, and a measurements pane 116. The events pane 114 displays information on patient events in an events by time view. The events by time view shows patient event information organized by date and time. Executing the “Events By Time” hyperlink 120 displays patient event information for the selected time window by date and time in the events pane 114. In FIG. 6, the selected time window for viewing events in the events pane 114 and viewing graphs in the measurements pane 116 is from 1600 hours on Nov. 10, 2003 to 1600 hours on Nov. 12, 2003.

When the events pane 114 is viewed in the events by time view, a data depository or folder 118 is displayed for each day in the display. Patient events 122 are organized into data depositories or folders 118. The data depositories 118 could be represented in a number of ways, including but not limited to folders, hierarchies, tree diagrams, flow charts, and timelines. The data depositories 118 can be configured to store data for any time period that is included in the user-specified window of time for the summary window. When the data depository 118 is expanded or opened, the patient events 122 are displayed in a list below the data depository. The list of patient events is displayed in reverse chronological order so that the most recent patient event is shown at the top of the list, but chronological order can be used as well. To view the information for a particular day, a user must click or perform the necessary user action on the data depository or folder 118 to open it. To hide the information for a particular day, the user must click or perform the necessary user action on the data depository or folder 118 again to hide the data. All data depositories or folders 118 are open by default when a user accesses the clinical summary.

For each patient event 122, the event time and event type are displayed. Each event type is preferably displayed in a different color. The user may select the colors to use for each event type. The event time is the time the event was ordered, administered, or resulted, but any other times associated with the user-specified patient data can also be used. For laboratory results, the results and the collected date/time are displayed. For cultures, imaging, radiology and EKG results, the collection date and time are displayed. For medication administrations, the action and dose are displayed.

The displayed patient events and event values in the clinical summary window are executable actions that allow a user to access additional information about the event or event value or to perform additional actions on the event or event value. Selecting a patient event value could, for instance, take the user into another activity in the health care information system or a separate system specific to the event value. For example, selecting a laboratory result could take the user to a results review activity, wherein the activity could display additional detailed or related information, or perform additional actions on a larger set of data than the user-specified patient data configured to be shown in the clinical summary. Selecting an event value could also execute an action that would display more detailed information in a report, or juxtapose the information on the existing graphical representation in the measurements pane. Users can also select patient events and event values for later use, such as in documentation. Saving the patient events and event values includes saving all information associated therewith, as opposed to saving the information as text only.

Hovering a pointing device over a time in the events by time view creates a line indicator 124 in the graph for that time. If the events pane is in events-by-time or events-by-type view and a user hovers a pointing device over an event time on the events pane, a vertical line 124 appears on the graph of the measurements pane 116 corresponding to the selected event time. Visual cues other than a vertical line could also be used.

FIG. 6 illustrates a sample screen shot of the events pane of a clinical summary window, in an “Events By Time” view. The events by time view preferably shows patient event information organized by date and time. A data depository or folder 126 preferably includes the patient events 128 listed by time for a particular date, such as Oct. 1, 2003 as shown in FIG. 6. All of the patient events 128 that occurred on Oct. 1, 2003, for example, are organized into a data depository or folder 126 organized by date and time.

The patient events 128 are preferably listed by time in reverse chronological order and include event types such as medication administrations, imaging, EKG and radiology, and laboratory events. Other event types may include cultures, drip administrations, blood gas and vent settings, etc. The display listing for laboratory events preferably includes the event time, the event type, the event results and the event values. The display listing for cultures, imaging, radiology, and EKG events preferably includes the event time, the event type and the event results. The display for medication administrations preferably includes the event time, the event type, the medication administered and the dose. Abnormal patient data is preferably highlighted or displayed in a distinguishable font and/or typeface, such as a bolded, red typeface, as shown in FIG. 6, so that users are quickly alerted to the presence of the abnormal patient data.

FIG. 7 is a sample screen shot illustrating yet another embodiment of a clinical summary 130 of patient information in accordance with the present invention. The clinical summary 130 preferably includes a patient name and information area 132 above a clinical summary window 136 and an activities area 134 next to the clinical summary window 136. The clinical summary 130 further includes a time window user action area 138 for selecting and/or changing the range of time for viewing patient events in the summary window 136, a views user action area 140 for selecting and/or changing the views for viewing patient events in the summary window 136, an events pane 142, and a measurements pane 144. The events pane 142 displays information on patient events in an events by type view. The events by type view shows patient event information organized by event type. Executing the “Events By Type” hyperlink displays patient event information for the selected time window by event type in the events pane.

The patient events 146 listed in the events pane 142 are organized into a plurality of data depositories or folders 148. The patient events 146 listed in FIG. 7 include laboratory events, imaging, EKG, and radiology events, medication administrations, drip administrations, and blood gas and vent settings. Which patient events are displayed is preferably determined by the user record. For example, blood gas information can be matched to ventilator settings based on the collection time of the blood gas components and the charted time of the ventilator setting. The present invention also has the ability to correlate data from different areas in the patient record in this fashion. As a result, different types of data can be presented together based on the time of entry, at the option of the user. The present invention can also associate a blood gas event having an event time of 1:00 pm with the vent setting event having the closest event time, such as a vent setting event that occurred at 1:05 pm. The corresponding blood gas event values and ventilator setting event values can be displayed on the same line in the events pane to show a potential relationship. The events-by-type view is capable of displaying other modalities of information contained in the patient record, including but not limited to procedure notes, progress notes, and surgical procedures.

In the measurements pane 144, a different line graph 150 is displayed for each measurement. A dot 152 is displayed on a line graph 150 to indicate that a measurement was made at the corresponding time. When a user hovers a pointing device over a measurement dot 96, the dot 96 enlarges and a “ToolTip” or information summary box 98 is displayed to provide information about the measurement 96.

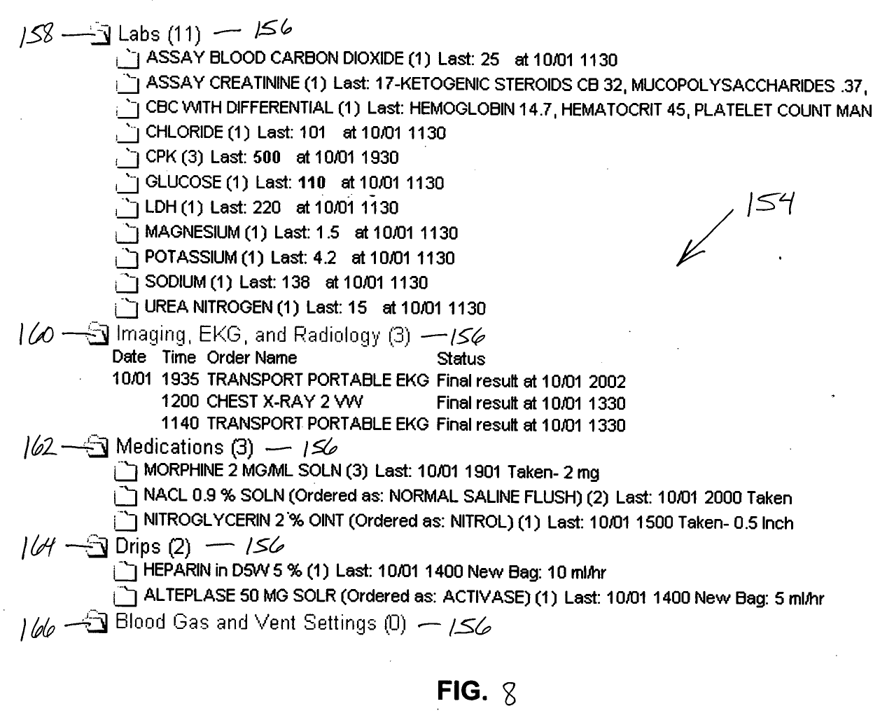

FIG. 8 illustrates a sample screen shot of another embodiment of the events pane of a clinical summary window, in an “Events By Type” view. The events-by-type view shows patient data organized by event type. The clinical summary window preferably comprises an events pane that displays all of the events that have been recorded for a patient within a specified range of time. The events pane displays user-specified patient data as a textual list of patient events 154. Patient events preferably include all actions taken, procedures performed, and measurements recorded for the patient, including but not limited to medication administrations, laboratory tests, surgical procedures, and biomedical device readings.

The patient events 154 are preferably organized in data depositories or folders 156. The event types shown in FIG. 8 include “Labs” 158, “Imaging, EKG, and Radiology” 160, “Medications” 162, “Drips” 164, and “Blood Gas and Vent Settings” 166.

The labs folder 158 preferably displays a subfolder for each type of laboratory order that was resulted during the selected window of time. Components are displayed by procedure name. The latest results are displayed on the same line as the procedure name. Clicking or performing the necessary user action on one of the lab orders will pull up a detailed order report. Next to each subfolder, the most recent results and the date and time of those results are displayed. A user can open each subfolder to view the results for each laboratory order of that type. The system may be configured to provide the user with a reference range of normal event values automatically, by selecting the event value, by hovering over the event value, or in any other suitable manner.

The imaging, EKG and radiology folder 160 preferably displays a list of the results of all imaging, EKG, and radiology orders that were collected during the selected window of time. Components are displayed by procedure name. The latest results are displayed on the same line as the procedure name. Clicking or performing the necessary user action on one of the imaging orders will pull up a detailed order report. Orders that were resulted on the current day but were collected outside of the selected time window are displayed in a distinguishable font and/or typeface. If the user does not have access to sensitive information about the patient, sensitive orders are not displayed.

The medications folder 162 preferably displays a subfolder for each type of medication that was administered to the patient during the selected window of time. Preferably, only the medications administered are shown. The latest administration is preferably listed on the same line as the medication name. Next to each subfolder, the date and time of the most recent administration is preferably displayed. A user can open each subfolder to view information about each administration of the medication that occurred during the selected window of time. Note that some actions may be excluded from the display for convenience or security reasons. For example, a user may not need to see medications that were missed, so missed administrations may be excluded from the display. Information is excluded based on settings in the user profile record.

The drips folder 164 preferably displays a subfolder for each type of medication that was administered to the patient via a drip bag during the selected window of time. Preferably, only the medications administered are shown. The latest administration is preferably listed on the same line as the medication name. The system preferably checks for drips that have started up to 24 hours prior to the start of the selected time window. This is done so that any currently-running drips that were started before the selected time window are included in the display, even if no actions were taken on those drips during the selected time window.

The blood gas and vent settings folder 166 preferably displays a list of blood gas components and vent settings. Blood gas result components and vent setting data from the flowsheet are preferably combined into a single row based on the time of collection or entry. The blood gas components preferably come from result components that are part of laboratory procedures, and the vent settings preferably come from values recorded in the documentation flowsheet activity. Which blood gas and vent settings are displayed is determined by settings in the user profile record. Blood gas information is preferably matched to vent settings based on the collection time of the blood gas components. The system preferably looks for a vent setting an hour prior to the collection time. This look back time can be changed. If a vent setting is not matched to a blood gas component, the vent setting preferably appears in the display as its own line of data.

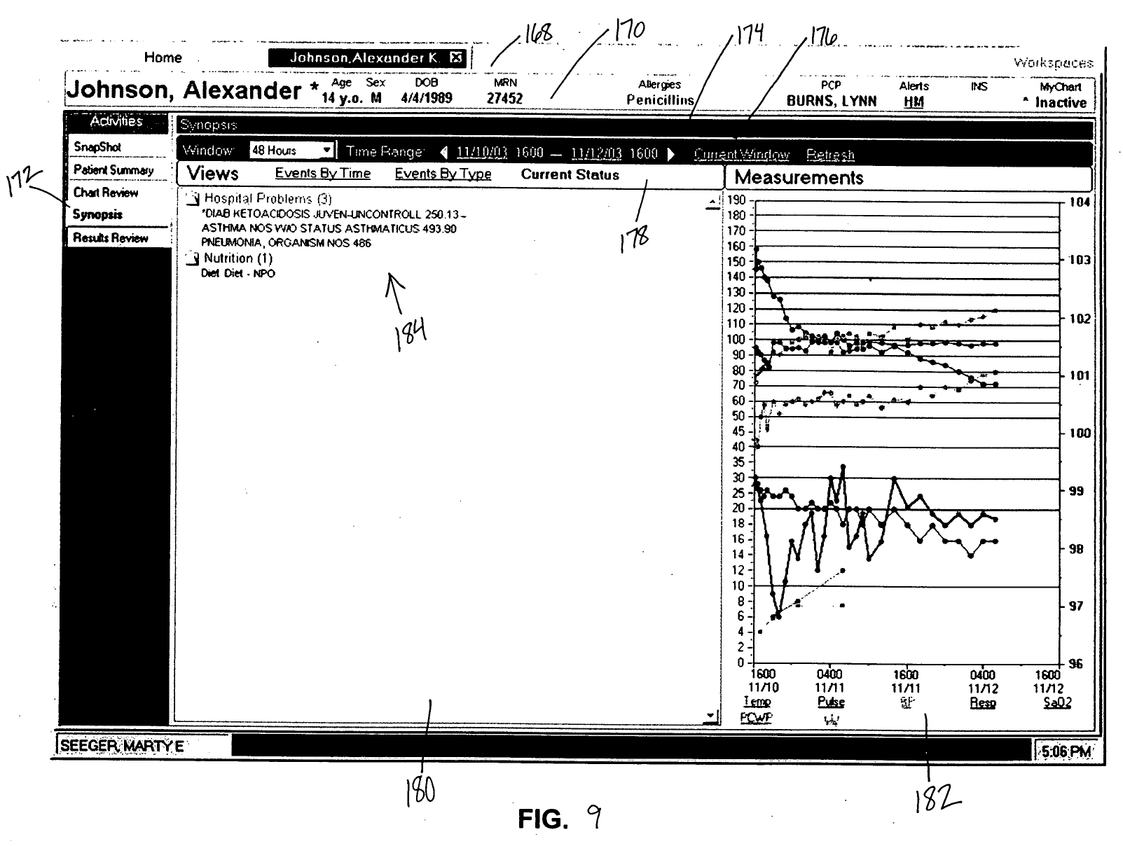

FIG. 9 is a sample screen shot illustrating still another embodiment of a clinical summary 168 of patient information in accordance with the present invention. The clinical summary 168 preferably includes a patient name and information area 170 above a clinical summary window 174 and an activities area 172 next to the clinical summary window 174. The clinical summary 168 further includes a time window user action area 176 for selecting and/or changing the range of time for viewing patient events in the summary window 174, a views user action area 178 for selecting and/or changing the views for viewing patient events in the summary window 174, an events pane 180, and a measurements pane 182. The events pane 180 displays information on patient's current status 184 in a current status view. The current status view displays the most recently recorded information about the patient's current status, such as the patient's problem list, medical history, allergies, immunizations, orders, nutritional information, and any other relevant clinical data. The current status view is preferably not affected by the selected window or span of time, but displays user-specified patient data that may not be time or event specific.

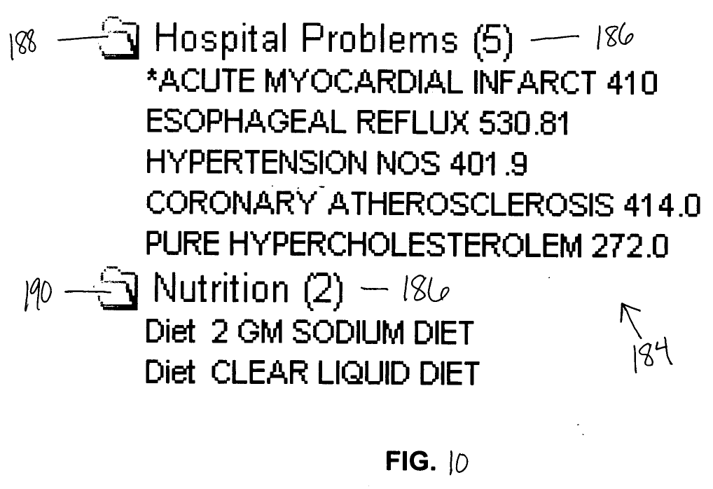

FIG. 10 is a sample screen shot illustrating the events pane with “Current Status” view data displayed in the clinical summary of FIG. 9. The patient's current status 184 listed in the events pane 180 are organized into a plurality of data depositories or folders 186. The current status folders 186 display information about the patient's currently active hospital problems and the patient's nutrition information.

The hospital problems folder 188 preferably displays a list of the patient's currently active hospital problems. The primary problem is preferably indicated with an asterisk (*) or other distinguishable feature. Problems are preferably sorted using the same sorting conditions that apply in the problem list activity. Preferably, a user can select a hospital problem from the list under the hospital problems folder 188, such as “Esophageal Reflux” shown in FIG. 10, and access more information about the selected hospital problem.

The nutrition folder 190 preferably displays nutrition information including currently active diet orders, currently active Total Parenteral Nutrition (TPN) orders, and currently active medication orders that have pharmaceutical subclasses that are set to display in this folder. Any other current patient data on the health care information system could also be included in the current status view. In addition, if a particular type of user-specified patient data has not been recorded for the patient, the system can be configured to display an empty data depository, indicating that no activity has taken place. The subclasses to display and the result components are set in the user profile record. Abnormal results are displayed in red boldface text. The patient's PO/NPO (per os/nulla per os) status as specified in the inpatient information tab of the demographic activity.

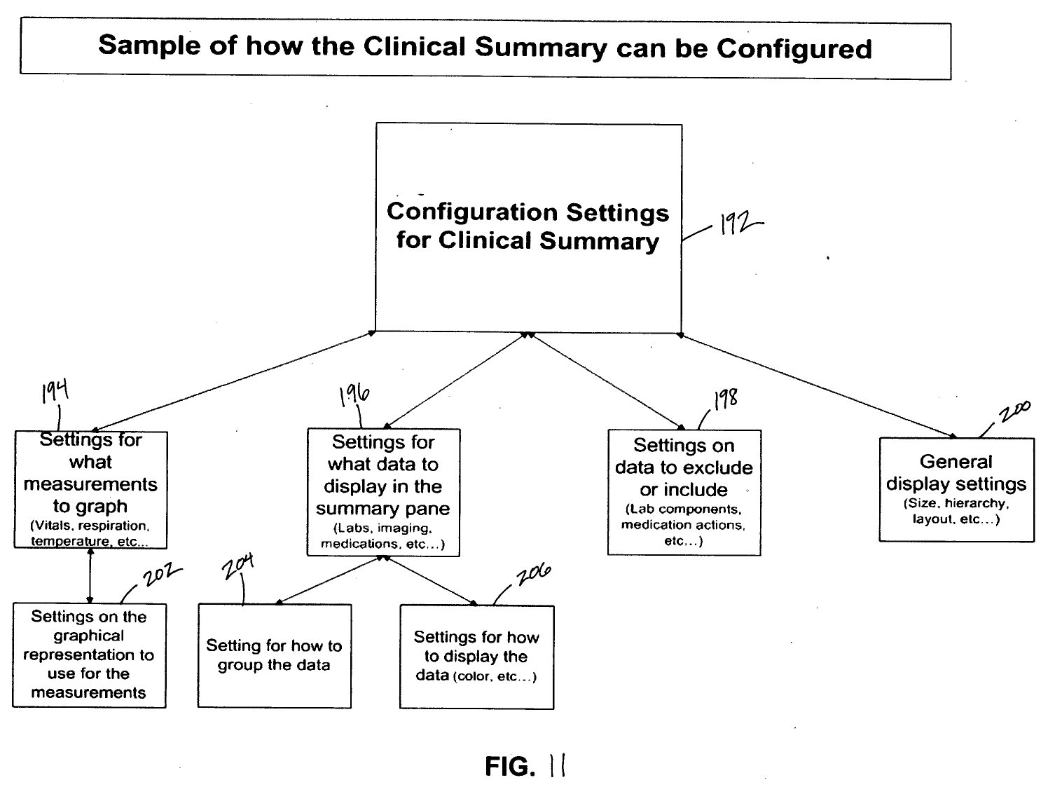

FIG. 11 is a diagram illustrating the configuration settings 192 for the clinical summary of the present invention. The present invention allows for the user or the user's system administrator to choose from a wide range of variables for display in the summary window. For example, users or system administrators can choose general display settings 200, including the colors used in the summary window and the size of the summary window. More importantly, users or system administrators can choose measurement data settings and events data settings, including which measurement data 194 to display in the measurements pane and which patient data 196 to display in the events pane.

In choosing the measurement data, users can choose which sets of measurement data to graph 194 and also choose the type of graphical format 202, including the colors or line types used for each set of measurement data, any number of data sets can be displayed on the graph at one time. For example, the user or system administrator could choose to display all the blood pressure, respiration, height, output, and temperature data collected in the specified window of time, and choose to display each set of measurement data in a different color.

In choosing the patient data for the events pane, users can choose how to group the data 204, how to display the data 206, and choose which data to include or exclude from the display 198. Preferably, the present invention defaults to show all data available in the health information system for a particular event, and the user or system administrator then chooses which data to exclude, at reference number. For instance, a user may choose to display medication events, but choose to exclude cancelled, held or stopped medications from the display. Likewise, a user or system administrator may want to include laboratory events in the display, but want to exclude some of the components of a CBC test so that only the components that are relevant to their decision-making process are displayed. The system also preferably defaults to show results excluded in the user record if those results are abnormal, but allows users to choose to exclude the abnormal results as well. For example, if a user chooses to exclude the white blood count component of the CBC test, but the results of the test are abnormal, the present invention will display the abnormal results despite the user's choice to exclude them, unless the user specifically chooses to exclude the abnormal results as well.

Users can also choose the type of report to display in the current status view of the events pane and the number of hours the clinical summary system will look back in the health information system to find data to display in the current events view when choosing the patient data for the events pane. Preferably, the summary system will pull data that starts at the beginning of the hospital shift in which the user-specified look back time appears. The organizational structure of the display, such as the arrangement of the data depositories, and the general display settings such as the color and font used for particular event types can preferably also be configured by the user or system administrator in the user record.

Additionally, the user record also contains the security settings that further control the data displayed in the summary window. For example, a system administrator could enter different security data for clinicians and receptionists. A receptionist may not have access to certain confidential information about patients, and thus the present invention will preclude that information from being displayed when a receptionist is using the clinical summary system.

Being able to configure the user record allows users to customize the clinical summary system to meet their needs. Users can create multiple versions of the clinical summary system, and save those versions for appropriate use. For example, a user could create a version for use on her personal computer, a version for use with all nurses that is saved and shared with all nurses, a version for a common group of patients, such as diabetes patients, or a version for a particular health care setting, such as the emergency department or intensive care unit.

This high-level of configuration allows the system to be implemented in a fashion that prevents information overload for users. Although the preferred embodiment is directed toward the use of the present invention in an acute setting, the present invention is useful in other health care settings as well. For example, the clinical summary could be used in a physical therapy setting to track improvements over time; in a ambulatory setting to track progress of chronic diseases, such as diabetes, over time; as follow-up to a surgery to review relevant data acquired while the surgery was being performed; or in other settings as one skilled in the art will appreciate. In addition, any data stored in the health information system could be used or displayed in the present invention. Such information may include billing data, scheduling data, and any other patient-related data; there is no inherent limit to the data that could be displayed in the clinical summary.

Most of the setup that a user need to perform in order to configure the summary is done at the user profile level. Configuration screens are included to configure the application. The configuration screens allow a user to configure the reports that display in the events pane, determine how long the system looks back to retrieve patient data, provide available time windows, and actions and components to exclude from display. The configuration screens also allow a user to specify which nutritional and blood gas components are displayed. The configuration screens further allow a user to specify which flowsheet rows are graphed. And a user can also specify a unique color for each measurement that is graphed.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention.

What is claimed is:

1. A system for providing a clinical summary of patient information in a health care setting, the system comprising:
a graphical user interface in communication with a health care information system for accessing patient data, the graphical user interface capable of displaying a clinical summary of the patient data in a summary window; and
a user record allowing a user to specify the patient data displayed in the summary window.

2. The system of claim 1, wherein the clinical summary includes textual and graphical elements.

3. The system of claim 1, wherein the summary window includes an events pane and a measurements pane.

4. The system of claim 3, wherein the events pane displays the user-specified patient data organized as a list of patient events, and the measurements pane displays the user-specified patient data in a graphical format.

5. The system of claim 4, wherein the patient events include a plurality of event types.

6. The system of claim 3, wherein the events pane includes multiple views.

7. The system of claim 6, wherein the multiple views include a list of patient events by time, a list of patient events by type, and a list of current patient status.

8. The system of claim 7, wherein the list of patient events by time displays the user-specified patient data organized in data depositories and listed in reverse chronological order for a user-specified time span.

9. The system of claim 7, wherein the list of patient events by time displays the user-specified patient data organized in data depositories and listed in chronological order for a user-specified time window.

10. The system of claim 7, wherein the list of patient events by type displays the user-specified patient data organized in data depositories and grouped by event type for a user-specified time window.

11. The system of claim 7, wherein the list of current patient status displays the user-specified patient data organized in data depositories and pertaining to a patient's current status.

12. The system of claim 4, wherein each patient event is displayed in a different user-specified color corresponding to the event type.

13. The system of claim 3, wherein the events pane displays event types, event times, and event values.

14. The system of claim 13, wherein selecting a displayed event time on the events pane causes a visual cue corresponding to the selected event time to be displayed on the measurements pane.

15. The system of claim 4, wherein the graphical format includes visually identifiable data points corresponding to the user-specified patient data displayed in the summary window.

16. The system of claim 15, wherein users can select a data point from the measurements pane and access additional information about the data point.

17. The system of claim 15, wherein users can select a data point from the measurements pane and access a separate module in the health information system containing information pertaining to the data point.

18. The system of claim 15, wherein users can select data points from the measurements pane and save the data points for use in documentation.

19. The system of claim 18, wherein all information pertaining to the data points is also saved for use in documentation.

20. The system of claim 4, wherein the measurements pane includes a legend.

21. The system of claim 20, wherein users can interact with the legend to selectively display or hide the user-specified patient data displayed in the graphical format.

22. The system of claim 4, wherein a user can select patient data on the events pane and display the selected data on the measurements pane.

23. The system of claim 4, wherein the measurements pane can display multiple sets of patient data simultaneously.

24. The system of claim 23, wherein each set of patient data displayed on the measurements pane is displayed in a different user-specified color.

25. The system of claim 23, wherein each set of patient data displayed in the measurements pane is displayed in a different user-specified line type.

26. The system of claim 23, wherein users can selectively hide or display each set of patient data.

27. The system of claim 1, wherein the user record is configurable.

28. The system of claim 1, wherein the patient data displayed in the summary window can include abnormal patient data and normal patient data, and wherein abnormal patient data is displayed differently than normal patient data to alert users to the presence of the abnormal patient data.

29. The system of claim 1, wherein the patient data displayed in the summary window can include preliminary patient data and final patient data, and wherein the preliminary patient data is displayed differently than the final patient data to alert users of the presence of the preliminary patient data.

30. The system of claim 1, wherein users can select from the patient data displayed in the summary window, access additional information about the selected patient data, generate detailed reports including the selected patient data, and generate graphical representations including the selected patient data.

31. The system of claim 1, wherein the summary window displays the patient data for a user-specified time period.

32. The system of claim 1, wherein the clinical summary system is an integrated activity of the health information system.

33. The system of claim 1, wherein the clinical summary system is a plug-in activity of the health information system.

34. The system of claim 1, wherein the graphical user interface communicates with the health information system using a framework supporting a plurality of activities.

35. The system of claim 1, wherein the health information system supports a plurality of applications.

36. The system of claim 1, wherein the summary window can be configured to allow a plurality of time spans to be displayed.

37. The system of claim 36, wherein a user can choose a time span to be displayed.

38. The system of claim 1, wherein the patient data displayed in the summary window can include patient data that was ordered in a user-specified time span, and patient data that was resulted in the user-specified time span.

39. The system of claim 38, wherein the patient data that was ordered in the user-specified time span is displayed differently than the patient data that was resulted during the user-specified time span.

40. The system of claim 1, wherein the user-specified patient data can include multiple types of patient data.

41. The system of claim 40, wherein a first type of patient data can be correlated and displayed together with a second type of patient data in the clinical summary to show a potential relationship.

42. The system of claim 40, wherein a first type of patient data can be associated with a second type of patient data using a user-specified time span.

43. The system of claim 1, further comprising configurable security settings for selectively controlling the display of the user-specified patient data.

44. The system of claim 1, wherein a user can select patient data displayed in the summary window and save the patient data for later use.

45. The system of claim 1, wherein users can customize the clinical summary.

46. The system of claim 45, wherein users can save customized views of the clinical summary.

47. The system of claim 45, wherein users can access customized views of the clinical summary.

48. The system of claim 45, wherein users can customize the clinical summary for an individual or group of patients.

49. The system of claim 45, wherein users can customize the clinical summary for an individual or group of clinicians.

50. The system of claim 45, wherein users can customize the clinical summary for a particular health care setting.

51. A method for providing a clinical summary of patient data in a health care setting, the method comprising the steps of:
providing a graphical user interface in communication with a health information system for accessing patient data, the graphical user interface capable of displaying a clinical summary of the patient data in a summary window in a tabular format and a graphical format;
selecting the patient data to be displayed; and
displaying the selected patient data in a summarized form in the summary window.

52. The method of claim 51, further comprising the step of controlling the display of the selected patient data based on security settings.

53. A system for providing a clinical summary of patient data in a health care setting, the system comprising:
a graphical user interface in communication with a health information system for accessing patient data, the graphical user interface capable of displaying a clinical summary of the patient data in a summary window in a tabular format and a graphical format;
a user record allowing a user to specify the patient data displayed in the summary window;
wherein the user record includes security settings for selectively controlling the display of the user-specified patient data; and
wherein a user can select from the displayed patient data, access additional information about the selected patient data, generate detailed reports including the selected patient data, and generate graphical representations including the selected patient data.
